(19) United States
(12) Patent Application Publication
(10) Pub. No.: US 2016/0213541 A1
(43) Pub. Date: Jul. 28, 2016

(54) TABLE DRIVING SYSTEM FOR PATIENT TABLE

(71) Applicant: General Electric Company, Schenectady, NY (US)

(72) Inventors: K S MANJUNATHA, Bangalore (IN); Nishad POOVANKAVIL, Bangalore (IN); Karthikeyan VEERASWAMY SATHYAMURTHY, Bangalore (IN); Shankar Murthy UDUPA, Bangalore (IN); Sriram Visvanathan IYER, Bangalore (IN)

(21) Appl. No.: 14/915,280

(22) PCT Filed: Aug. 25, 2014
(86) PCT No.: PCT/US2014/052483

§ 371 Date: Feb. 29, 2016

(30) Foreign Application Priority Data
Aug. 30, 2013 (IN) 3884/CHE/2013

(51) Int. Cl. A61G 13/06; A61G 13/00

(52) U.S. Cl. CPC A61G 13/06; A61G 13/0018

(57) ABSTRACT

A table driving system of a patient table is disclosed. The table driving system comprises one or more carriage unit capable of moving along a base member of the patient table. The patient table comprises a table top, the base member and a table lifting unit connected to the base members and a bottom portion of the table top. The table driving system also includes one or more actuating units. An actuating unit has its ends operatively connected to a carriage unit and the table lifting unit. The actuating unit is configured to retractably extend to operate the table lifting unit for the table top to attain a raised configuration and a lowered configuration. The carriage unit is configured to move along the base member to facilitate the operation of the actuating unit.

### TECHNICAL FIELD

The subject matter disclosed herein relates to patient table of holding patients for medical imaging systems. More specifically the subject matter relates to a table driving system for assisting in varying vertical position of patient table.

### BACKGROUND OF THE INVENTION

Patient tables are required for supporting a subject undergoing a medical procedure such as a diagnostic procedure, a therapeutic procedure and a surgical procedure. These patient tables have driving systems that helps in positioning the patient with respect to an image capturing system of a medical imaging system. Positioning of the patient involves movement of the patient table in multiple axes. Thus the driving system configured to position the patient table is desired to be capable of moving in multiple axes.

For moving the patient table along multiple axes, the driving system may include numerous drive assemblies. A drive assembly may include for example a rack and pinion drive assembly, a screw drive assembly and a hydraulic drive assembly. In another embodiment the drive assembly may be a cross-bar drive assembly for controlling the vertical position of the patient table. Further, the motion of the patient table along the third direction can be achieved using a cross bar drive assembly. The cross bar drive assembly converts a linear motion in a horizontal plane to a linear motion in a vertical plane. The cross bar drive assembly comprises a scissor assembly and an actuator assembly for actuating the motion of the scissor assembly in the horizontal plane. Support rails provide for co-operation during the horizontal movement of the scissor assembly. The scissor assembly may be slidably mounted between a first roller assembly and a second roller assembly. The scissor assembly comprises structural members such as one or more pairs of cross bars configured for enabling the movement of the patient support table along the vertical axis. Each pair of cross bars comprises a first cross bar and a second cross bar. The second cross bar being movably coupled to the first cross bar using a pivot joint. The table needs to be lowered so that the patient can lie on the table. However the position and orientation of the actuating unit restrict the vertical movement of the table beyond a certain point. Moreover the actuating unit requires a high stroke length and major portion of the force generated is not used for lifting the table.

Thus there is a need for a table driving system for achieving low height in a table in a convenient manner.

### BRIEF DESCRIPTION OF THE INVENTION

The above-mentioned shortcomings, disadvantages and problems are addressed herein which will be understood by reading and understanding the following specification.

As discussed in detail below, embodiments of the invention include a table driving system of a patient table. The table driving system comprises one or more carriage unit capable of moving along a base member of the patient table. The patient table comprises a table top, the base member and a table lifting unit connected to the base members and a bottom portion of the table top. The table driving system also includes one or more actuating units. An actuating unit has its ends operatively connected to a carriage unit and the table lifting unit. The actuating unit is configured to retractably extend to operate the table lifting unit for the table top to attain a raised configuration and a lowered configuration. The carriage unit is configured to move along the base member to facilitate the operation of the actuating unit.

In another embodiment a patient table having a table driving system is disclosed. The patient table includes a table top for holding a patient, a base member and a table lifting unit operatively connected to the base member and a bottom portion of the table top. The table driving system comprises one or more carriage units capable of moving along the base member and one or more actuating units. An actuating unit has its ends operatively connected to a carriage unit and the table lifting unit. The actuating unit is configured to retractably extend to operate the table lifting unit for the table top to attain a raised configuration and a lowered configuration. The carriage unit is configured to move along the base member to facilitate the operation of the actuating unit.

### BRIEF DESCRIPTION OF THE DRAWINGS

FIG. 1 illustrates a patient table for holding a patient for medical imaging procedure in a raised configuration in accordance with an embodiment;

FIG. 2 illustrates the patient table in a lowered configuration in accordance with an embodiment;

FIG. 3 illustrates the patient table with an actuating unit in an expanded configuration in accordance with an embodiment;

FIG. 4 illustrates the patient table with an actuating unit in a collapsed configuration in accordance with an embodiment;

FIG. 5 illustrates a side view of a table driving system used in a patient table; and

FIG. 6 illustrates a perspective view of a patient table having an actuating unit oriented parallel to the ground in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. It should be understood that the various embodiments are not limited to the arrangements and instrumentality shown in the drawings. The following detailed description is, therefore, not to be taken as limiting the scope of the invention.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

A table driving system of a patient table is disclosed. The table driving system comprises one or more carriage unit capable of moving along a base member of the patient table. The patient table comprises a table top, the base member and a table lifting unit connected to the base members and a bottom portion of the table top. The table driving system also includes one or more actuating units. An actuating unit has its ends operatively connected to a carriage unit and the table lifting unit. The actuating unit is configured to retractably extend to operate the table lifting unit for the table top to attain a raised configuration and a lowered configuration. The carriage unit is configured to move along the base member to facilitate the operation of the actuating unit.

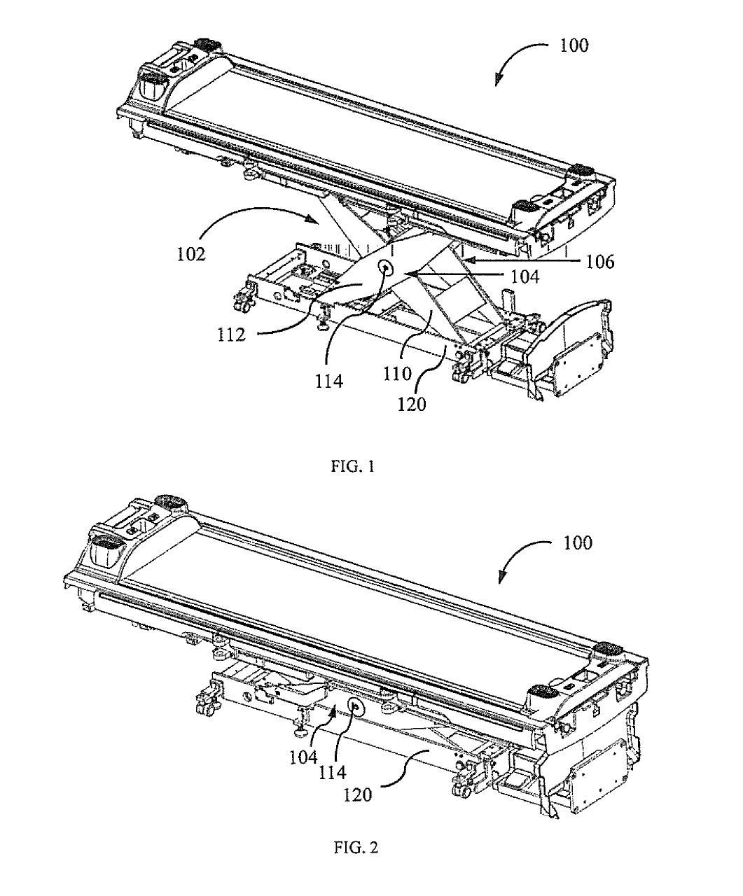

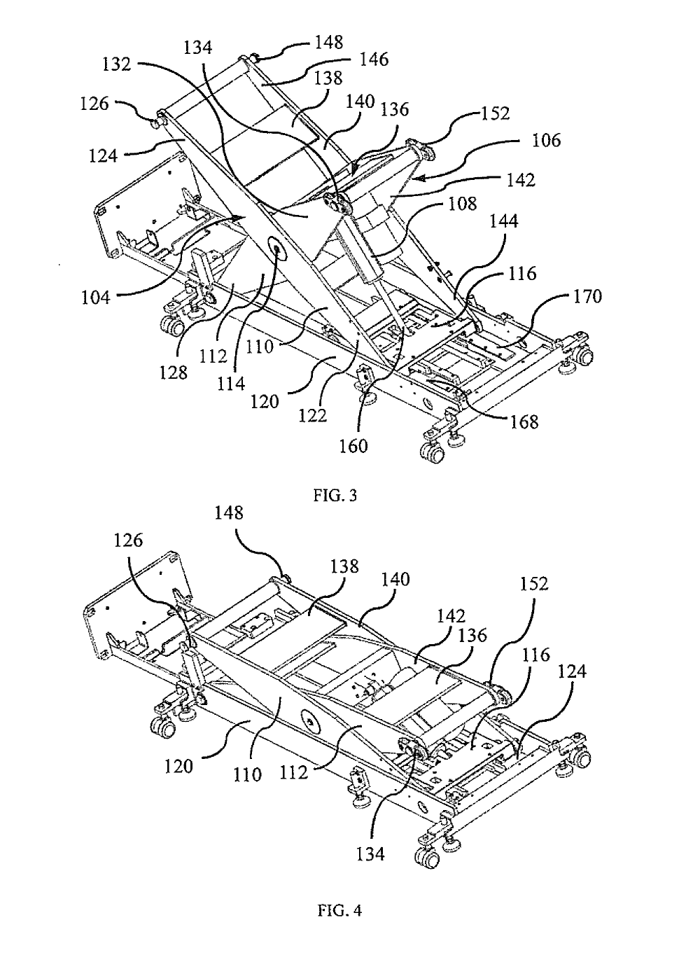

Various embodiments of the invention provide a patient table 100 as shown in FIG. 1. The patient table 100 is used for holding patients for performing medical imaging procedure. The patient table 100 may be used for holding and positioning the patient in different medical imaging systems such as an X-ray system, a computed tomography system, a single photon emission computed tomography system, a positron emission tomography system, and a magnetic resonance imaging system. The patient table 100 needs to be lowered for the patient to lie on the table for performing an imaging procedure. Once the patient lies down, height of the patient table 100 can be increased or raised. The height of the patient table 100 can be varied using a table driving system. The table driving system includes a table lifting unit for instance a cross bar assembly 102. In an embodiment the cross bar assembly 102 may include one or more scissor assemblies such as a scissor assembly 104 and a scissor assembly 106 and an actuating unit 108. The scissor assembly 104 may include two scissor members i.e. a scissor member 110 and a scissor member 112. The scissor member 110 and the scissor member 112 are connected to each other using a pivot joint 114. The scissor member 110 may be connected to a carriage unit 116. The carriage unit 116 includes pivot joints such as a pivot joint 118 and is positioned proximal to a base member 120. An end 122 of the scissor member 110 is connected to the pivot joint 118. Other end 124 of the scissor member 110 is connected to a pivot joint 126. The scissor member 112 have an end 128 connected to a pivot joint 130 at the base member 120 and an end 132 connected to a roller assembly 134. The roller assembly 134 may engage with a guiding track (not shown). The guiding track may be positioned below the patient table 100. The cross bar assembly 102 also includes another scissor assembly 106 positioned opposite to the scissor assembly 104. The scissors assembly 104 and scissors assembly 106 may be connected using center blocks 136 and 138. The scissor assembly 106 includes a scissor member 140 and a scissor member 142. The scissor member 140 have an end 144 connected to the carriage unit 116 and another end 146 connected to a pivot joint 148. The scissor member 142 have an end 150 connected to the base member 120 and an end connected to a roller assembly 152. The roller assembly 152 moves along a guiding track positioned below the patient table 100. When the scissor assembly 110 attains a collapsed configuration, the patient table 100 is lowered as shown in FIG. 4. Further when the scissor assembly 104 attains an expanded configuration, the patient table 100 is raised as shown in FIG. 3. To attain these configurations of the patient table 100, the roller assemblies 134 and 152 roll along their respective guiding tracks to assist the scissor members 110, 112, 140 and 142 to move with respect to their respective pivot joints. It may be appreciated that the table lifting unit as described herein is in accordance with an embodiment and thus any other arrangements forming a table lifting unit may be within the scope of this disclosure.

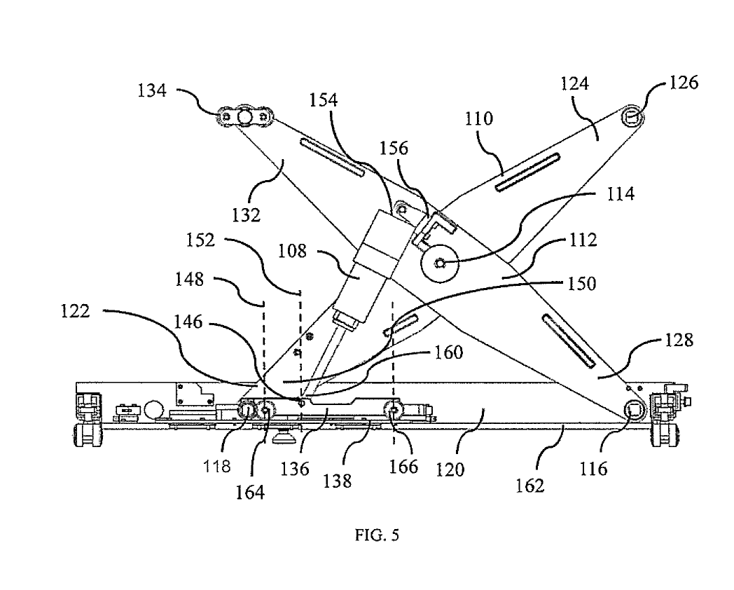

Now referring to the actuating unit 108, the actuating unit 108 may be connected to the one or more scissor assemblies using one or more connecting means. The actuating unit 108 may be a telescopic actuating unit. The actuating unit 108 may be a hydraulic actuating unit, a pneumatic actuating unit, an electro-hydraulic actuating unit and any other actuating units. In an embodiment an end 154 of the actuating unit 108 may be connected to the scissor assemblies 104 and 106 using a clevis block unit 156 as shown in FIG. 5. In a scenario the end 154 may be connected to the clevis block unit 156 so that the actuating unit 108 may have multiple degrees of freedom of movements. The clevis block unit 156 is connected to a connecting means 158 engaged with the scissor assembly 104 and the scissor assembly 106. Another end 160 of the actuating unit 106 is connected to the carriage unit 116 as shown in FIG. 3 and FIG. 5. In an embodiment the end 160 may be pivotally connected with the carriage unit 116. This enables the actuating unit 108 to perform angular movements while moving the patient table 100 in a vertical direction. Thus a pivot connecting means may be present in the carriage unit 116 that may be connected to the end 132. The carriage unit 116 may be movably engaged with one or more guiding systems (i.e. a guiding system 162) assembled on a base member 140 of the patient table 100 as illustrated in FIGS. 1 and 5. The carriage unit 116 includes multiple movement facilitators that engage with the guiding system 162 facilitating the movement of the carriage unit 116. The carriage unit 116 may move in an X-axis or parallel to the ground. For instance the carriage unit 116 may have multiple rollers such as a roller 164 and a roller 166 that engage with the guiding system 162 such as guiding rails 168 and 170 to allow the movement of the carriage unit 116. The carriage unit 116 and their rollers 164 and 166 are positioned between the scissor assemblies 104 and 106.

Now when the patient table 100 needs to attain a raised configuration, the actuating unit 108 may extend to assist the scissor assemblies 104 and 106 to attain the expanded configuration. The actuating unit 108 while extending may also move due to the movement of the carriage unit 116 along the guiding system 162. The actuating unit 108 while extending exerts force at the clevis block unit 156 which enables the carriage unit 116 to move parallel to the ground. The actuating unit 108 retracts back so that the patient table 100 can attain the lowered configuration. In an embodiment the patient table 100 may attain a height around 400 mm from the ground. The actuating unit 108 may be aligned at an angle to a horizontal plane 172 or the ground when the patient table 100 is in the lowered configuration. The movement of the carriage unit 116 facilitates in achieving less inclination of the actuating unit 108 with respect to a horizontal plane 172 or the ground. The angle of orientation of the actuating unit 108 with respect to the horizontal axis or the ground may vary from 0° to 90°. However it may be envisioned that the angle of orientation of the actuating unit 108 may vary and the variation in the range of angle provided above may be in accordance with an embodiment.

The actuating unit 108 may be connected to the carriage unit 116 at a point 174. This point 174 may be such that force acting on the pivot joint 118 may be in the positive direction so that the pivot joint 118 does not displace and remain on the guiding system 162 when the carriage unit 116 moves. The point 174 where the actuating unit 108 may be connected to the carriage unit 116 may vary based on a span and length of scissor members of scissor assemblies 104 and 106. In an embodiment an axis 176 passing through the point 174 of connection between the actuating unit 108 and the carriage unit 116 lies between a central axis 178 of a first movement facilitator (i.e. the roller 166) and a central axis 180 of a second movement facilitator (i.e. the roller 166). In a scenario a predefined distance (d) is maintained between the central axis 180 and the axis 176 passing through the point 174. It may be noted that the point 174 may vary based on factors other than the span and length of the scissor members without deviating from the scope of this disclosure. The force acting on the rollers 164 and 166 may be due to the force exerted by the actuating unit 108 while extending. The actuating unit 108 extends to enable the carriage unit 116 to move thereby facilitating the actuating unit 116 to be more efficient in lifting the patient table 100 with less effort and also reduces the stroke length of the actuating unit 116 (i.e. less length of extension) to lift the patient table 100. In an embodiment the force applied by the actuating unit 116 may vary from 3.6 to 3.8 times the weight of the patient on the patient table 100.

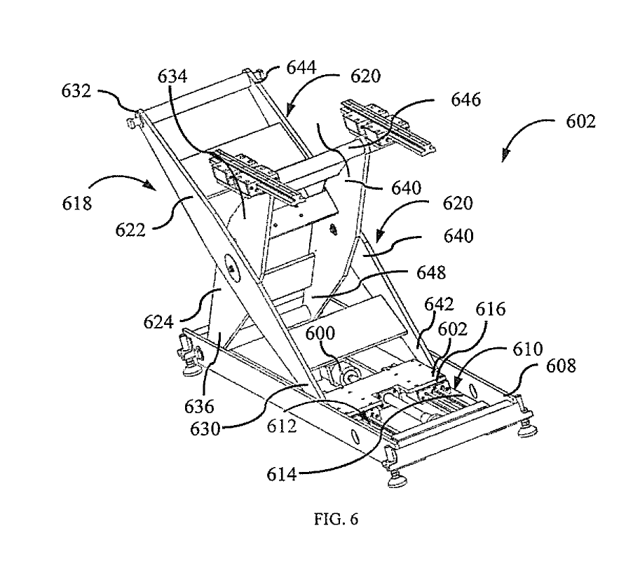

FIG. 6 is a schematic illustration of a table driving system including an actuating unit 600 aligned in a horizontal orientation in a patient table 602 in accordance with an embodiment. The actuating unit 600 is connected to a carriage unit 604. As illustrated the actuating unit 600 is oriented parallel to the ground. The actuating unit 600 also have an end 606 connected to a base member 608. The actuating unit 600 extends and retracts thereby moving the carriage unit 604 in a to-and-fro direction parallel to the ground. Multiple movement facilitators such as a movement facilitator, a movement facilitator 610 and a movement facilitator 612 assist the carriage unit 604 to move. The movement facilitator 610 and the movement facilitator 612 may be but not limited to a linear motion guide unit, and a sliding movement guiding unit. The movement facilitator 610 include a sliding track 614 and a guide way 616 that matches with the sliding track 614 to facilitate the movement of the carriage unit 604. A table lifting unit such as scissor assemblies 618 and 620 are connected to the carriage unit 600. The scissor assembly 618 includes a scissor member 622 and a scissor member 624. Further the scissor assembly 620 includes a scissor member 626 and a scissor member 628. The scissor member 622 may have an end 630 connected to the carriage unit 600 and an end 632 connected to the patient table 600. The scissor member 624 have an end 634 connected to the patient table 600 and an end 636 connected to the base member 608. Now in the case of the scissor assembly 620 includes a scissor member 638 and a scissor member 640. The scissor member 638 have its end 642 connected to the carriage unit 604 and an end 644 connected to the patient table 602. The scissor member 640 have an end 646 connected to the patient table 602 and an end 648 connected to the base member 608.

During operation when the carriage unit 600 moves in to-and-fro direction due to the extending and retracting operation of the actuating unit 600, the scissor assemblies 618 and 620 attain a collapsed and expanded configuration. This enables the patient table 602 to be lowered and raised from the ground.

This written description uses examples to disclose the invention, including the best mode, and also to enable any person skilled in the art to practice the invention, including making and using any computing system or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A table driving system of a patient table, the table driving system comprising:
at least one carriage unit capable of moving along a base member of the patient table, wherein the patient table comprises a table top, the base member and a table lifting unit connected to the base member and a bottom portion of the table top; and
at least one actuating unit, the actuating unit having its ends operatively connected to the carriage unit and the table lifting unit, wherein the actuating unit is configured to retractably extend to operate the table lifting unit for the table top to attain a raised configuration and a lowered configuration, wherein the carriage unit is configured to move along the base member to facilitate the operation of the actuating unit.

2. The table driving system of claim 1, further comprising at least one guiding system connected to the base member, wherein the carriage unit is movably engaged with the guiding system to move along the base member for facilitating the actuating unit to operate.

3. The table driving system of claim 2, wherein the carriage unit comprises a plurality of movement facilitators configured to enable the carriage unit to move along the guiding system in a horizontal direction in response to functioning of the actuating unit.

4. The table driving system of claim 1, wherein the plurality of movement facilitators comprises at least one first movement facilitator and at least one second movement facilitator, an axis passing through a point of connection between the actuating unit and the carriage unit lies between a central axis of the first movement facilitator and a central axis of the second movement facilitator.

5. The table driving system of claim 4, wherein a predefined distance is maintained between the central axis of the first movement facilitator and the axis passing through the point of connection between the actuating unit and the carriage unit.

6. The table driving system of claim 1, wherein the actuating unit connected to the carriage unit is at an angle ranging about 10° to 90° with respect to a horizontal axis.

7. The table driving system of claim 1, wherein the actuating unit connected to the carriage unit is oriented parallel to a horizontal axis.

8. The table driving system of claim 1, wherein the patient table may attain a height of about 380 to 400 mm from the ground.

9. The table driving system of claim 1, wherein the table lifting unit is pivotably connected to the carriage unit, an axis of a pivotal connection between the table lifting unit and the carriage unit is different from an axis of a connection between the actuating unit and the carriage unit.

10. A patient table comprising:
a table top for holding a patient;
a base member;
a table lifting unit operatively connected to the base member and a bottom portion of the table top;
a table driving system comprising:
at least one carriage unit capable of moving along the base member; and
at least one actuating unit, the actuating unit having its ends operatively connected to the carriage unit and the table lifting unit, wherein the actuating unit is configured to retractably extend to operate the table lifting unit for the table top to attain a raised configuration and a lowered configuration, wherein the carriage unit is configured to move along the base member to facilitate the operation of the actuating unit.

11. The table driving system of claim 10, further comprising at least one guiding system assembled in the base member, wherein the carriage unit is movably engaged with the guiding system to move along the base member for facilitating the actuating unit to operate.

12. The table driving system of claim 10, wherein the carriage unit comprises at least one movement facilitator configured to enable the carriage unit to move along the guiding system in a horizontal direction in response to functioning of the actuating unit.

13. The table driving system of claim 10, wherein the actuating unit connected to the carriage unit is at an angle ranging about 10° to 90° with respect to a horizontal axis when the table top is in the raised configuration.

14. The table driving system of claim 10, wherein the actuating unit connected to the carriage unit is oriented parallel to a horizontal axis.

15. The table driving system of claim 10, wherein the patient table may attain a height of about 380 to 400 mm from the ground.

16. The table driving system of claim 10, wherein the table lifting unit is pivotably connected to the carriage unit, and an axis of a pivotal connection between the table lifting unit and the carriage unit is different from an axis of a connection between the actuating unit and the carriage unit.
